(19) United States
(12) Patent Application Publication
(10) Pub. No.: US 2011/0031435 A1
(43) Pub. Date: Feb. 10, 2011

(54) (METH)ACRYLIC PRESSURE-SENSITIVE ADHESIVE FOAM AND METHOD FOR PRODUCING THE SAME

(76) Inventors: Masaki Yoda, Sagamihara (JP); Rina Mawatari, Sagamihara (JP)

Correspondence Address: 3M INNOVATIVE PROPERTIES COMPANY, PO BOX 33427, ST. PAUL, MN, 55133-3427, US

(21) Appl. No.: 12/988,084

(22) PCT Filed: Apr. 20, 2009
(86) PCT No.: PCT/US09/41066

§ 371 Date: Oct. 15, 2010

(30) Foreign Application Priority Data
Apr. 25, 2008 (JP) 2008-116163

(51) Int. Cl. C09K 5/00; B29C 44/34

(52) U.S. Cl. 252/71; 264/51

(57) ABSTRACT

A (meth)acrylic pressure-sensitive adhesive foam reduced in the amount of a foaming adjuvant compared with the conventional foam and having a high air bubble content, and a method for producing the same are provided. The foam includes a partial polymer having (a) one or more alkyl (meth)acrylate monomers having one reactive unsaturated group, the alkyl group having 12 or less carbon atoms, (b) a monomer for crosslinking, which is copolymerizable with the component (a), and (c) a copolymer of the component (a) and the component (b); a thermally conductive filler; and a foaming adjuvant containing surface modified nanoparticles having a particle diameter of 20 nm or less, wherein a crosslinked structure containing the component (c) is formed in the curable composition.

### TECHNICAL FIELD

The present disclosure relates to a (meth)acrylic pressure-sensitive adhesive foam and a method for producing the same. More particularly, the present disclosure relates to a thermally conductive (meth)acrylic pressure-sensitive adhesive foam and a method for producing the same.

### BACKGROUND

A conventional (meth)acrylic foamed pressure-sensitive adhesive sheet is produced by curing a foam formed by mixing a (meth)acrylic curable composition with an inert gas (for example, nitrogen gas) under stirring. In such a production method, it is important that the inert gas is dispersed into and mixed with the (meth)acrylic curable composition finely and uniformly; therefore, fluorochemical surfactants or surface modified nanoparticles are used as a foaming adjuvant and these foaming adjuvants are mixed with the (meth)acrylic curable composition when used. Accordingly, these foaming adjuvants are contained in the (meth)acrylic foamed pressure-sensitive adhesive sheet obtained after curing.

An example of use of a fluorochemical surfactant as the foaming adjuvant is disclosed in Japanese Unexamined Patent Publication (Kokai) No. 2006-22189.

An example of use of surface modified nanoparticles as the foaming adjuvant is disclosed in Publication of Japanese Translation of PCT International Application (Kohyo) No. 2004-518793. Surface modified nanoparticles are often inferior in foaming performance compared with a fluorochemical surfactant, and it may be necessary to add a large amount of the surface modified nanoparticles so as to obtain a desired foaming performance.

Japanese Unexamined Patent Publication (Kokai) No. 2006-213845 discloses “a thermally conductive pressure-sensitive adhesive sheet-like foam-molded article (F) having an average foam cell diameter of 50 to 550 μm, obtained by sheet-molding and heating a heat-conductive pressure-sensitive adhesive composition (E) comprising 100 parts by weight of a (meth)acrylic acid ester polymer (A1), from 20 to 55 parts by weight of a (meth)acrylic acid ester monomer mixture (A2m), from 50 to 500 parts by weight of a heat-conductive inorganic compound (B), from 0.1 to 5 parts by weight of an organic peroxide thermal polymerization initiator (C2) and from 0.01 to 0.8 parts by weight of a thermally decomposable organic foaming agent (D), thereby effecting sheet molding of the heat-conductive pressure-sensitive adhesive composition (E), polymerization of the (meth)acrylic acid ester monomer mixture (A2m), and thermal decomposition of the thermally decomposable organic foaming agent (D).”

### SUMMARY

An object of the present disclosure is to provide a (meth)acrylic pressure-sensitive adhesive foam having a high content of air bubbles in which the amount of a foaming adjuvant is decreased compared with the prior art, and a method for producing the same.

According to the present disclosure, there is provided a pressure-sensitive adhesive foam which is a foamed cured product of a curable composition comprising a partial polymer comprising or consisting essentially of (a) one or more alkyl (meth)acrylate monomers having one reactive unsaturated group, the alkyl group having 12 or less carbon atoms, (b) a monomer for crosslinking, which is copolymerizable with the component (a), and (c) a copolymer of the component (a) and the component (b); a thermally conductive filler; and a foaming adjuvant containing surface modified nanoparticles having a particle diameter of 20 nm or less, wherein a crosslinked structure containing the component (c) is formed in the curable composition.

According to a first embodiment of the present disclosure, there is provided a pressure-sensitive adhesive foam which is a foamed cured product of a curable composition comprising a partial polymer comprising or consisting essentially of (a) one or more alkyl (meth)acrylate monomers having one reactive unsaturated group, the alkyl group having 12 or less carbon atoms, (b1) one or more monomers having two or more reactive unsaturated groups, and (c1) a copolymer of the component (a) and the component (b1), the amount of the component (c1) being from 2 to 15% by weight based on the weight of the partial polymer; a thermally conductive filler in the amount of 100 to 250 parts by weight based on 100 parts by weight of the partial polymer; and a foaming adjuvant containing surface modified nanoparticles having a particle diameter of 20 nm or less, in the amount of 0.1 to 1.5 parts by weight based on 100 parts by weight of the partial polymer, wherein the crosslinked structure formed in the curable composition is a crosslinked copolymer of the component (a) and the component (b1) and when the content of the air bubbles of the pressure-sensitive adhesive foam is expressed by the volume percentage based on the entire volume of the foam, the value of (parts by weight of the foaming adjuvant based on 100 parts by weight of the resin component of the curable composition)/(content of air bubbles of the pressure-sensitive adhesive foam) is from 0.02 to 0.05.

According to a second embodiment of the present disclosure, there is provided a pressure-sensitive adhesive foam which is a foamed cured product of a curable composition comprising a partial polymer comprising or consisting essentially of (a) one or more alkyl (meth)acrylate monomers having one reactive unsaturated group, the alkyl group having 12 or less carbon atoms, (b2) one or more monomers having a carboxyl group, and (c2) a copolymer of the component (a) and the component (b2), the amount of the component (c2) being from 2 to 15% by weight based on the weight of the partial polymer; a thermally conductive filler in the amount of 60 to 300 parts by weight based on 100 parts by weight of the partial polymer, the thermally conductive filler being a metal hydroxide having a basic group on the particle surface; and a foaming adjuvant containing surface modified nanoparticles having a particle diameter of 20 nm or less, in the amount of 0.1 to 1.5 parts by weight based on 100 parts by weight of the partial polymer, wherein the crosslinked structure formed in the curable composition is a crosslinked structure in which the component (c2) is crosslinked through the component (b2) in the component (c2) and the thermally conductive filler, and wherein when the content of the air bubbles of the pressure-sensitive adhesive foam is expressed by the volume percentage based on the entire volume of the foam, the value of (parts by weight of the foaming adjuvant based on 100 parts by weight of the resin component of the curable composition)/(content of air bubbles of the pressure-sensitive adhesive foam) is from 0.02 to 0.05.

According to a third embodiment of the present disclosure, there is provided a pressure-sensitive adhesive foam which is a foamed cured product of a curable composition comprising a partial polymer comprising or consisting essentially of (a) one or more alkyl (meth)acrylate monomers having one reactive unsaturated group, the alkyl group having 12 or less carbon atoms, (b1) one or more monomers having two or more reactive unsaturated groups, (b2) one or more monomers having a carboxyl group, and (c3) a copolymer of the component (a), the component (b1) and the component (b2), the amount of the component (c3) being from 2 to 15% by weight based on the weight of the partial polymer; a thermally conductive filler in the amount of 60 to 300 parts by weight based on 100 parts by weight of the partial polymer, the thermally conductive filler being a metal hydroxide having a basic group on the particle surface; and a foaming adjuvant containing surface modified nanoparticles having a particle diameter of 20 nm or less, in the amount of 0.1 to 1.5 parts by weight based on 100 parts by weight of the partial polymer, wherein the crosslinked structure formed in the curable composition is a crosslinked structure in which the component (a) is copolymerized with the component (b1) to form a crosslink and in which the component (c3) is crosslinked through the component (b2) in the component (c3) and the thermally conductive filler, and wherein when the content of the air bubbles of the pressure-sensitive adhesive foam is expressed by the volume percentage based on the entire volume of the foam, the value of (parts by weight of the foaming adjuvant based on 100 parts by weight of the resin component of the curable composition)/(content of air bubbles of the pressure-sensitive adhesive foam) is from 0.02 to 0.05.

Also, according to the present disclosure, there is provided a method for producing a pressure-sensitive adhesive foam, comprising the steps of preparing a partial polymer comprising or consisting essentially of (a) one or more alkyl (meth)acrylate monomers having one reactive unsaturated group, the alkyl group having 12 or less carbon atoms, (b) a monomer for crosslinking, which is copolymerizable with the component (a), and (c) a copolymer of the component (a) and the component (b); mixing the partial polymer with a thermally conductive filler; adding a foaming adjuvant containing surface modified nanoparticles having a particle diameter of 20 nm or less to the partial polymer to obtain a curable composition in which a crosslinked structure containing the component (c) is formed; mechanically foaming the curable composition; and curing a molded article of the foamed curable composition.

Also, according to another embodiment of the present disclosure, there is provided a method for producing a pressure-sensitive adhesive foam, which comprises the steps of preparing a partial polymer comprising or consisting essentially of (a) one or more alkyl (meth)acrylate monomers having one reactive unsaturated group, the alkyl having 12 or less carbon atoms, (b1) one or more monomers having two or more reactive unsaturated groups, and (c1) a copolymer of the component (a) and the component (b1), the amount of the component (c1) being 2 to 15% by weight based on the weight of the partial polymer; mixing the partial polymer with a thermally conductive filler in the amount of 100 to 250 parts by weight based on 100 parts by weight of the partial polymer; adding a foaming adjuvant containing surface modified nanoparticles having a particle diameter of 20 nm or less, in the amount of 0.1 to 1.5 parts by weight based on 100 parts by weight of the partial polymer to the partial polymer, to obtain a curable composition in which a crosslinked structure that is a crosslinked copolymer of the component (a) and the component (b1) is formed; mechanically foaming the curable composition; and curing a molded article of the foamed curable composition. When the content of the air bubbles of the pressure-sensitive adhesive foam is expressed by a volume percentage based on the entire volume of the foam, a value of (parts by weight of the foaming adjuvant based on 100 parts by weight of the resin component of the curable composition)/(content of air bubbles of the pressure-sensitive adhesive foam) is from 0.02 to 0.05.

According to the present disclosure, even if the amount of the foaming adjuvant containing surface modified nanoparticles is decreased compared with the prior art, for example, the amount is decreased to half, it becomes possible to obtain a pressure-sensitive adhesive foam which has a sufficiently high content of air bubbles and is excellent in adhesion performance and flexibility. When the foaming adjuvant is used in the same amount as in the case of the prior art, a pressure-sensitive adhesive foam in lower density, which has improved adhesive characteristics, adhesion properties and sealing properties, can be produced. The pressure-sensitive adhesive foam of the present disclosure has thermal conductivity and is therefore particularly suited for use in heat radiation applications of electronic devices.

It should not be considered that the above descriptions disclose all embodiments of the present disclosure and all advantages with respect to the present disclosure.

### DETAILED DESCRIPTION

While typical embodiments of the present disclosure are described in detail below, they are for illustrative purpose only and the present disclosure is not limited to these embodiments.

The pressure-sensitive adhesive foam of the present disclosure is obtained by foaming and curing a curable composition comprising a partial polymer comprising or consisting essentially of (a) one or more alkyl (meth)acrylate monomers having one reactive unsaturated group, the alkyl group having 12 or less carbon atoms, (b) a monomer for crosslinking, which is copolymerizable with the component (a), and (c) a copolymer of the component (a) and the component (b); a thermally conductive filler; and a foaming adjuvant containing surface modified nanoparticles having a particle diameter of 20 nm or less. In the curable composition, a crosslinked structure containing the component (c) is formed. The term “monomer for crosslinking” in the component (b) means a monomer which enables forming a crosslinked structure through a moiety derived from the monomer for crosslinking when incorporated into the copolymer. The crosslink contained in the crosslinked structure is formed, for example, by covalent bonding, acid-base interaction or a combination thereof. This crosslinked structure enhances foamability of the curable composition and even when the amount of the foaming adjuvant is small compared with the conventional composition, a foam having a desired content of air bubbles can be formed by inhibiting defoaming during molding and curing steps.

The pressure-sensitive adhesive foam above can be produced, for example, by a method comprising the steps of preparing a partial polymer comprising or consisting essentially of (a) one or more alkyl (meth)acrylate monomers having one reactive unsaturated group, the alkyl group having 12 or less carbon atoms, (b) a monomer for crosslinking, which is copolymerizable with the component (a), and (c) a copolymer of the component (a) and the component (b); mixing the partial polymer with a thermally conductive filler; adding a foaming adjuvant containing surface modified nanoparticles having a particle diameter of 20 nm or less to the partial polymer to obtain a curable composition in which a crosslinked structure containing the component (c) is formed; mechanically foaming the curable composition; and curing a molded article of the foamed curable composition.

The pressure-sensitive adhesive foam of the present disclosure and a production method thereof are described in detail below by referring to several embodiments of the crosslinking form of the crosslinked structure, but the present disclosure is not limited to these embodiments.

The pressure-sensitive adhesive foam according to the first embodiment of the present disclosure is obtained by foaming and curing a curable composition comprising a partial polymer comprising or consisting essentially of (a) one or more alkyl (meth)acrylate monomers having one reactive unsaturated group, the alkyl group having 12 or less carbon atoms, (b1) one or more monomers having two or more reactive unsaturated groups, and (c1) a copolymer of the component (a) and the component (b1); a thermally conductive filler; and a foaming adjuvant containing surface modified nanoparticles. The copolymer as the component (c1) is a crosslinked copolymer having a crosslink produced by the copolymerization reaction of the component (a) and the component (b1) (i.e., a crosslink through a covalent bond) (hereinafter, as concerns the first embodiment, the copolymer as the component (c1) is sometimes referred to as a crosslinked copolymer), and this crosslinked copolymer is present as a crosslinked structure in the curable composition. Such a crosslinked structure enhances foamability of the curable composition and even when the amount of the foaming adjuvant is small compared with the conventional composition, a foam having a desired content of air bubbles can be formed by inhibiting defoaming during molding and curing steps.

The term “(meth)acryl” and “(meth)acrylate” used in the present disclosure mean both methacryl and acryl and both methacrylate and acrylate respectively.

The term “reactive unsaturated group” means a functional group having a polymerizable unsaturated carbon-carbon bond (a double bond or a triple bond) and specific examples thereof include an acryloyl group, a methacryloyl group, an allyl group, a methallyl group and a vinyl group.

The component (a) is a monofunctional alkyl (meth)acrylate monomer having one reactive unsaturated group and the alkyl group has 12 or less carbon atoms. The component (a) is one of the base components of the curable composition and is classified as a monomer having low polarity in the present disclosure. Examples of the (meth)acrylic monomer include n-propyl (meth)acrylate, n-butyl (meth)acrylate, n-amyl (meth)acrylate, n-hexyl (meth)acrylate, 2-ethylhexyl (meth)acrylate, n-octyl (meth)acrylate, isooctyl (meth)acrylate, n-nonyl (meth)acrylate, isononyl (meth)acrylate and n-decyl (meth)acrylate.

The component (b1) is a monomer having two or more reactive unsaturated groups and a crosslink is provided to a copolymer by the reaction of a plurality of reactive unsaturated groups. Examples of the monomer include polyfunctional (meth)acrylates such as hexanediol di(meth)acrylate, polyethyleneglycol di(meth)acrylate, polypropyleneglycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate and tetramethylolmethane tri(meth)acrylate; and allyl-based polyfunctional monomers such as triallyl isocyanurate. In order to effectively reduce defoaming during molding and curing steps by further enhancing foamability of the curable composition, it is preferred that the amount of the monomer having two or more reactive unsaturated groups is adjusted to about 0.01 parts by weight or more based on 100 parts by weight of the component (a) before the reaction and then the component (a) and the component (b1) are copolymerized. In order to more improve handling properties during foaming and molding steps and homogeneity of the foam by effectively preventing gelling of the curable composition, it is preferred that the amount of the monomer having two or more reactive unsaturated groups is adjusted to about 1.0 parts by weight or less based on 100 parts by weight of the component (a) before the reaction and then the component (a) and the component (b1) are copolymerized.

The component (c1) is a copolymer having a crosslink composed of polymer units derived from the component (a) and the component (b1). As an aspect, a partial polymer containing a crosslinked copolymer of the component (c1) as well as the component (a) and the component (b1), can be obtained by partial polymerization of a monomer mixture prepared by adding a polymerization initiator (d) to the component (a) and the component (b1). The partial polymerization of the monomer mixture can be carried out by radiation polymerization in which polymerization is initiated through irradiation with ultraviolet light or an electron beam in the presence of a photopolymerization initiator. As the photopolymerization initiator, for example, benzoin alkyl ether, acetophenone, benzophenone, benzyl methyl ketal, hydroxycyclohexyl phenyl ketone, 1,1-dichloroacetophenone and 2-chlorothioxanthone can be used. Examples of commercially available photopolymerization initiators include those which are commercially available from Ciba Japan K.K. under the trade name Irgacure, commercially available from Merck Ltd. Japan under the trade name Darocur and commercially available from Versicore Co. under the trade name Versicure. The polymerization initiator may be used alone, or two or more of them may be used in combination. Furthermore, a sensitizer may be used in combination. The amount of the polymerization initiator may be the amount conventionally used and is, for example, about 0.01 parts by weight or more and about 1.0 parts by weight or less based on 100 parts by weight of the component (a) before the partial polymerization.

The partial polymerization of the above monomer mixture may be carried out by thermopolymerization in place of radiation polymerization. Examples of the thermopolymerization initiator used in this case include an azo-based polymerization initiator (for example, 2,2′-azobisisobutyronitrile), a peroxide-based polymerization initiator (for example, dibenzoyl peroxide, t-butyl hydroperoxide) and a redox-based polymerization initiator. The amount of the thermopolymerization initiator is not specifically limited and may be the amount conventionally used as the thermopolymerization initiator.

The partial polymer thus obtained contains, in addition to the component (a) and component (b1) remaining in the state of unreacted monomers, the component (c1) having a crosslink formed by copolymerization of the component (a) and the component (b1). The component (c1) may have the unreacted reactive unsaturated group derived from the component (a) or the component (b1). Also, the polymerization initiator which was not reacted upon partial polymerization may remain in the partial polymer, and the remaining polymerization initiator can also be used in the curing step of the curable composition later.

As described above, in a certain aspect, the component (c1) in the partial polymer can be produced in-situ in the partial polymer by partial polymerization of the component (a) and the component (b1). Alternatively, a partial polymer used in the present disclosure may be produced by further adding the component (a) and/or the component (b1) to the partial polymer obtained by partial polymerization of the component (a) and the component (b1) mixed in a predetermined ratio, in order to appropriately adjust the amount of the component (c1) contained in the partial polymer. A partial polymer used in the present disclosure may also be produced by mixing a first partial polymer obtained by partial polymerization of the component (a) and the component (b1) mixed in a predetermined ratio, with only the component (a), only the component (b1), or a second partial polymer obtained by partial polymerization of the component (a) and the component (b1). In order to adjust the viscosity of the curable composition obtained by mixing such a partial polymer with a thermally conductive filler and a foaming adjuvant to a preferred value in the following foaming, molding and curing steps, the amount of the component (c1) is preferably adjusted to about 2% by weight or more and about 15% by weight or less based on the weight of the partial polymer. For example, the viscosity of the partial polymer is adjusted to about 1,000 mPa·s or more, and about 10,000 mPa·s or less or about 5,000 mPa·s or less.

After partial polymerization, a polymer having a crosslink, which is different from the crosslink derived from the component (b1), may be further formed in the partial polymer by using a crosslinkable compound used in a common adhesive, for example, an epoxy compound, an isocyanate compound or an aziridine compound. In this case, partial polymerization must be carried out by adding a monomer having a functional group capable of reacting with a reactive site of the above crosslinkable compound. As an example, when partial polymerization is carried out by adding a monomer having a hydroxyl group such as hydroxyethyl acrylate to the component (a) and the component (b1), a polymer having a different crosslink is produced in the partial polymer by reacting the hydroxyl group site derived from the monomer with an epoxy compound or an isocyanate compound.

However, in such a case, an additional crosslinking step is required, in addition to a partial polymerization step. Furthermore, because a crosslinking reaction using such a crosslinkable compound usually proceeds by heating, when a curable composition is stored as an intermediate raw material for a certain period of time, the physical properties of the composition may vary with a lapse of time (for example, thickening) and thus it may become difficult to produce a pressure-sensitive adhesive foam and to control the physical properties of the resulting foam. As described above, it is preferable to utilize partial polymerization using the component (a) and the component (b1).

The thermally conductive filler imparts thermal conductivity to the pressure-sensitive adhesive foam of the present disclosure. The thermally conductive filler may also impart strength to an air bubble wall contained in the foam before curing and contribute to reduction of defoaming in molding and curing steps. As the thermally conductive filler, for example, metal hydroxides, metal oxides, metals and ceramics can be used. Specific examples of the thermally conductive filler include aluminum hydroxide, magnesium hydroxide, aluminum oxide, silicon oxide, magnesium oxide, zinc oxide, titanium oxide, zirconium oxide, iron oxide, silicon carbide, boron nitride, aluminum nitride, titanium nitride, silicon nitride, titanium boride, carbon black, carbon fiber, carbon nanotube, diamond, nickel, copper, aluminum, titanium, gold and silver. The crystal form of these thermally conductive fillers may be any crystal form of these chemical species, for example, a hexagonal crystal or a cubic crystal. The particle diameter of the filler is preferably about 10 μm or more and about 150 μm or less. When the particle diameter of the filler is adjusted to about 150 μm or less, sufficient sheet strength can be ensured. In contrast, when the particle diameter of the filler is adjusted to about 10 μm or more, sufficient foamability can be ensured. In order to improve filling properties, a thermally conductive filler having a surface treated with silane or titanate may be used. The term “particle diameter” means the size of the longest length when a straight line drawn through the center of gravity of the filler is measured. The shape of the filler may be a regular or irregular shape and includes, for example, polygon, cube, oval, sphere, needle, plate, flake, or a combination thereof. The filler may be in the form of aggregated particles of a plurality of crystal particles. Of these fillers, aluminum hydroxide is particularly preferred because it is excellent in filling into the curable composition and can impart flame retardancy to the pressure-sensitive adhesive foam, and is also easily obtainable as a raw material (for example, cheap price). The amount of the thermally conductive filler is preferably about 100 parts by weight or more and about 250 parts by weight or less based on 100 parts by weight of the partial polymer. When the amount of the thermally conductive filler is about 100 parts by weight or more based on 100 parts by weight of the partial polymer, sufficient thermal conductivity can be imparted to the pressure-sensitive adhesive foam. When the amount is about 250 parts by weight or less, sufficient adhesive force can be ensured.

The foaming adjuvant contributes to more stably maintain air bubbles mixed with the curable composition upon the foaming step. The foaming adjuvant contains surface modified nanoparticles described above and examples thereof include those described in Kohyo (National Publication of Translated Version) No. 2004-518793. An example of the surface modified nanoparticles includes those obtained by modifying the surface of nanoparticles selected from the group consisting of silica, titania, alumina, zirconia, vanadia, ceria, iron oxide, antimony oxide, tin oxide, aluminum/silica and a combination thereof using a reagent such as silane, an alcohol, an organic acid, an organic base or an organotitanate. Silica having an organosilyl surface group obtained by using silica as nanoparticles and modifying the surface thereof using chlorosilane, long-chain alkyl or arylalkoxysilane, vinylalkoxysilane, mercaptoalkoxysilane, polyetheralkoxysilane or ((meth)acryloyloxy)alkylalkoxysilane is usually used. The particle diameter of the surface modified nanoparticles is preferably about 20 nanometers (nm) or less. When the particle diameter of the surface modified nanoparticles is about 20 nm or less, the effect as the foaming adjuvant is sufficiently exerted, and thus a pressure-sensitive adhesive foam containing a sufficient amount of air bubbles with excellent flexibility is obtained. The amount of the foaming adjuvant is preferably 0.1 parts by weight or more and about 1.5 parts by weight or less based on 100 parts by weight of the partial polymer. When the amount of the foaming adjuvant is about 0.1 parts by weight or more based on 100 parts by weight of the partial polymer, a sufficient amount of air bubbles can be introduced into the curable composition. When the amount is about 1.5 parts by weight or less, thermal conductivity of the level required to the objective applications of the pressure-sensitive adhesive foam can be obtained without excessively introducing air bubbles.

If necessary, when the content of the thermally conductive filler is comparatively large, a polar group-containing monomer may be added to the curable composition for the purpose of improving pressure-sensitive adhesive characteristics of the pressure-sensitive adhesive foam. Examples of the polar group-containing monomer include a polar group-containing (meth)acrylic monomer such as (meth)acrylic acid, hydroxyalkyl (meth)acrylate, or (meth)acrylamide; and a polar group-containing monomer having a polymerizable functional group, such as itaconic acid or vinyl acetate. Such a polar group-containing monomer is used in an amount sufficient to impart pressure-sensitive adhesion to the pressure-sensitive adhesive foam and the amount is usually about 30 parts by weight or less, and preferably 10 parts by weight or less, based on 100 parts by weight of the partial polymer. If necessary, a monomer having two or more reactive unsaturated groups, such as hexanediol diacrylate, which is the same as or different from the component (b1), may be further added to the curable composition, in order to control physical properties such as flexibility of the foam by varying the degree of crosslinking of the pressure-sensitive adhesive foam.

If necessary, other filler components such as glass beads, plastic beads, glass or plastic hollow microspheres, fibers or filaments, woven fabrics, nonwoven fabrics and pigments may be added to the curable composition so as to improve workability of the curable composition upon foaming, or strength and/or flame retardancy of the pressure-sensitive adhesive foam after curing.

As described above, when the polymerization initiator unreacted upon partial polymerization remains in the curable composition, the curable composition may be cured using the remaining polymerization initiator. Alternatively, the polymerization initiator is further added so as to promote curing. In the present disclosure, it is preferable to enable the curable composition to be ultraviolet curable using a photopolymerization initiator as the polymerization initiator to be added, in view of production efficiency.

Furthermore, other components contributing to the enhancement of various characteristics of the pressure-sensitive adhesive foam, for example, tackifiers, coupling agents and impact resistance modifiers may be added to the curable composition in an amount which does not adversely affect foaming, molding and curing of the curable composition.

The curable composition thus obtained has viscosity suited for formation of stable air bubbles in the curable composition. The viscosity of the curable composition is preferably adjusted to about 5,000 mPa·s or more at the temperature of the curable composition upon the foaming step, for example, a working temperature (for example, 25° C.) in a stirring/mixing device so as to promote formation of air bubbles and/or to prevent coalescence of air bubbles and floatation of the coalesced air bubbles. The viscosity of the curable composition is preferably adjusted to about 60,000 mPa·s or less so as to enable the production of the pressure-sensitive adhesive foam to be more stable by effectively preventing separation of the unreacted monomer and the crosslinked copolymer and enabling uniform mixing of the curable composition under stirring.

According to the first embodiment of the present disclosure, a pressure-sensitive adhesive foam containing a foamed cured product of the curable composition is provided. The pressure-sensitive adhesive foam of the present disclosure exhibits more excellent adhesion performance and flexibility even when the amount of a foaming adjuvant containing surface modified nanoparticles drastically decreases compared with a conventional curable composition, by virtue of the crosslink of the component (c1) that is a crosslinked copolymer of the component (a) and the component (b1) contained in a partial polymer of a curable composition used as a precursor. When the foaming adjuvant is used in the same amount as that in the case of the prior art, it becomes possible to produce a pressure-sensitive adhesive foam in lower density, which is excellent in tackiness, adhesion and sealing.

The amount of the foaming adjuvant is determined by appropriately selecting or designing conditions and equipment with respect to foaming, molding and curing of the curable composition, in addition to the kind of the component (a) and the component (b1), the content of the crosslinked copolymer and the content of the thermally conductive filler, in consideration of the required size (for example, thickness), adhesion characteristics and applications of the pressure-sensitive adhesive foam. In the present disclosure, as a measure of foaming efficiency of the curable composition with respect to the amount of the foaming adjuvant, a value of (parts by weight of the foaming adjuvant based on 100 parts by weight of the resin component of the curable composition)/(content of air bubbles of the pressure-sensitive adhesive foam) (=η_{form}) is used. The smaller the value, a pressure-sensitive adhesive foam having a larger content of air bubbles can be obtained using a smaller amount of the foaming adjuvant. The expression “resin component of the curable composition” as used herein means all materials constituting the resin component of the resulting adhesive foam by foaming a curable composition, for example, the component (a), the component (b1) and the component (c1) contained in the above partial polymer, as well as optional additional components including a polar group-containing monomer such as acrylic acid and an additional monomer having two or more reactive unsaturated groups. The expression “parts by weight of the foaming adjuvant based on 100 parts by weight of the resin component of the curable composition” as used herein means parts by weight of the foaming adjuvant used upon foaming based on 100 parts by weight of the resin component. The content of the air bubbles of the pressure-sensitive adhesive foam is represented by a volume percentage based on the entire volume of the foam, and the details will be described in Examples hereinafter. η_{form} of the pressure-sensitive adhesive foam of the present disclosure obtained by foaming and curing of the above curable composition is about 0.02 or more and about 0.05 or less. By adjusting η_{form} within the above range, sufficient thermal conductivity can be imparted to the pressure-sensitive adhesive foam while maintaining flexibility of the pressure-sensitive adhesive foam.

The average diameter of air bubbles contained in the pressure-sensitive adhesive foam is usually about 300 μm or less. The content of the air bubbles of the pressure-sensitive adhesive foam may be appropriately adjusted by the foaming step according to the purposes. As the content of the air bubbles increases, the sheet becomes more flexible. The content of the air bubbles is preferably adjusted to 5% by volume or more based on the entire volume of the foam so as to impart sufficient flexibility to the sheet. The content of the air bubbles is preferably adjusted to 25% by volume or less based on the entire volume of the foam so as to ensure sufficient sheet strength. According to the present disclosure, such a sheet can be produced under the conditions where the amount of the foaming adjuvant is decreased compared with the prior art.

The pressure-sensitive adhesive foam of the present disclosure can be produced by foaming and curing of the above curable composition. In the foaming step, a known bubble mixing method can be used and a bubble mixing method using a mechanical foaming mechanism is preferred. Examples of the mechanical foaming mechanism include shaking, vibration, stirring and high-speed stirring and a combination thereof of the curable composition; mixing, nozzle injection and bubbling of a gas for forming air bubbles into the curable composition; and a combination thereof.

In the method using a mechanical foaming mechanism, a vibrational (vibration type) stirring/mixing device described in Japanese Unexamined Patent Publication (Kokai) No. 2002-80802 may be used. The vibrational stirring/mixing device is usually equipped with therein a casing including a passageway through which a fluid flows, and a stirring blade capable of vibrating in an axial direction of the casing, disposed in the casing. When such a device is used, since the shear force applied to the curable composition contributes to efficient dispersion of air bubbles, fine and uniform air bubbles can be dispersed without increasing the temperature of the composition.

A gas, which does not disturb molding and curing of the curable composition when mixed with the curable composition, can be usually used as the gas for forming air bubbles. An inert gas such as argon or nitrogen can be used as the air bubble forming gas, and nitrogen is preferably used in view of cost.

As described above, a pressure-sensitive adhesive foam is formed by curing the foamed curable composition. For example, when the pressure-sensitive adhesive foam is used as a foamed pressure-sensitive adhesive sheet, the foamed curable composition may be applied on a substrate to form a tape or a sheet. Similar to the above partial polymerization, the curing step can be carried out by irradiating the foamed curable composition with radiation such as ultraviolet light or an electron beam when a photopolymerization initiator is used. When a thermopolymerization initiator is used, the curing step can be carried out by heating the foamed curable composition. Since curing is carried out at low temperature within a comparatively short time, the foamed curable composition is preferably cured by irradiating with ultraviolet light. In this case, since oxygen in the air tends to inhibit ultraviolet polymerization, the curing step is preferably carried out in an inert gas such as nitrogen, argon or carbon dioxide. For example, after interposing the foamed curable composition between two substrates, curing may be carried out so as not to contact oxygen contained in the air with the curable composition. As the substrate in the case of molding, a plastic film, for example, a polyethylene terephthalate (PET) film can be used. The substrate is advantageously a transparent film having permeability to ultraviolet light since it is possible to irradiate with ultraviolet light from the side of the substrate.

The pressure-sensitive adhesive foam according to the second embodiment of the present disclosure is obtained by foaming and curing a curable composition comprising a partial polymer comprising or consisting essentially of (a) one or more alkyl (meth)acrylate monomers having one reactive unsaturated group, the alkyl group having 12 or less carbon atoms, (b2) one or more monomers having a carboxyl group, and (c2) a copolymer of the component (a) and the component (b2); a thermally conductive filler which is a metal hydroxide having a basic group on the particle surface; and a foaming adjuvant containing surface modified nanoparticles. A crosslinked structure in which the component (c2) is crosslinked through the component (b2) in the component (c2) and the thermally conductive filler is formed in the curable composition. In this embodiment, a plurality of copolymer molecules are attracted to the thermally conductive filler through an acid-base interaction brought about between the carboxyl group derived from the component (b2) contained in the component (c2) and the basic group present on the particle surface of the thermally conductive filler, as a result, a crosslink is formed among the plurality of copolymer molecules. This crosslinked structure enhances foamability of the curable composition and even when the amount of the foaming adjuvant is small compared with the conventional composition, a foam having a desired content of air bubbles can be formed by inhibiting defoaming during molding and curing steps.

As for the component (a), the same as the monomer described for the first embodiment can be used.

The component (b2) is a monomer having a carboxyl group and as a result of reaction of the component (b2) with the component (a), a carboxyl group capable of acid-base interaction with the basic group present on the particle surface of the thermally conductive filler is introduced into the copolymer. Examples of the monomer include (meth)acrylic acid, itaconic acid and maleic acid, and acrylic acid can be advantageously used.

The component (c2) is a copolymer composed of polymerization units derived from the components (a) and (b2) and has a carboxyl group in the copolymer molecule. In one embodiment, a monomer mixture prepared by adding (d) a polymerization initiator to the components (a) and (b2) is partially polymerized, whereby a partial polymer containing a copolymer of the component (c2) in addition to the components (a) and (b2) is obtained. The partial polymerization of the monomer mixture can be performed by radiation polymerization or thermopolymerization as described in the first embodiment. As for the photopolymerization initiator used in the radiation polymerization, the sensitizer used, if desired, and the thermal polymerization initiator used in the thermal polymerization, those described for the first embodiment can be used.

The monomer mixture has a composition comprising, based on the weight of the monomer mixture, from about 80% by weight to about 98.99% by weight of the component (a), from about 1% by weight to about 19.99% by weight of the component (b2), and from about 0.01% by weigh to about 1.5% by weight of the component (d).

The thus-obtained partial polymer contains, as described above, the component (c2) that is a copolymer of the components (a) and (b2), in addition to the components (a) and (b2) remaining in an unreacted monomer state. The polymerization initiator that is not reacted at the partial polymerization may remain in the partial polymer, and this remaining polymerization initiator may be utilized later in the curing step of the curable composition.

In order to allow the curable composition obtained by mixing the thermally conductive filler and the foaming adjuvant with the partial polymer to have a viscosity suitable for the subsequent foaming, molding and curing steps, the amount of the component (c2) is preferably adjusted to be from about 2% by weight to about 15% by weight based on the weight of the partial polymer. For example, the viscosity at 25° C. of the partial polymer is controlled to be about 200 mPa·s or more or about 500 mPa·s or more and about 5,000 mPa·s or less or about 2,000 mPa·s or less.

The thermally conductive filler is a metal hydroxide particle having a basic group on the particle surface and not only imparts thermal conductivity to the pressure-sensitive adhesive foam of the present disclosure but also participates in the crosslink formation with the copolymer as the component (c2). Also, the thermally conductive filler may impart strength to the wall of an air bubble contained in the foam before curing and contribute to the reduction of defoaming in the molding and curing steps. Examples of the thermally conductive filler include aluminum hydroxide and magnesium hydroxide, and aluminum hydroxide may be advantageously used because it has good filling property in the curable composition, can impart flame retardancy to the pressure-sensitive adhesive foam and is easily obtainable as a raw material (for example, inexpensive). The mean particle diameter of the thermally conductive filler is from about 30 μm or more or about 40 μm or more and about 100 μm or less or about 80 μm or less. When the mean particle diameter of the thermally conductive filler is about 30 μm or more, sufficient foamability can be ensured, and when the mean particle diameter of the thermally conductive filler is about 100 μm or less, sufficient sheet strength can be ensured. The definition of the term “particle diameter” and the shape of the thermally conductive filler are as described in the first embodiment. The amount of the thermally conductive filler used is about 60 parts by weight or more or about 100 parts by weight or more and about 300 parts by weight or less or about 250 parts by weight or less, per 100 parts by weight of the partial polymer. When the amount of the thermally conductive filler used is about 60 parts by weight or more per 100 parts by weight of the partial polymer, sufficient thermal conductivity is imparted to the pressure-sensitive adhesive foam and at the same time a crosslink is formed between copolymer molecules, and when the amount used is about 300 parts by weight or less, sufficient adhesive force can be ensured and an undesirable increase in viscosity of the curable composition due to excessive crosslinking can be prevented.

As for the foaming adjuvant, a foaming adjuvant containing surface modified nanoparticles described for the first embodiment may be used. The particle diameter of the surface modified nanoparticles is preferably about 20 nm or less. When the particle diameter of the surface modified nanoparticles is about 20 nm or less, the effect as the foaming adjuvant is sufficiently exerted and a pressure-sensitive adhesive foam containing a sufficient amount of air bubbles and having excellent flexibility is thereby obtained. The amount of the foaming adjuvant used is preferably from about 0.1 parts by weight to about 1.5 parts by weight per 100 parts by weight of the partial polymer. When the amount of the foaming adjuvant used is about 0.1 parts by weight or more per 100 parts by weight of the partial polymer, a sufficient amount of air bubbles can be introduced into the curable composition, and when the amount used is about 1.5 parts by weight or less, thermal conductivity of the level required to the objective applications of the pressure-sensitive adhesive foam can be obtained without excessively introducing air bubbles.

A monomer having two or more reactive unsaturated groups (for example, hexanediol diacrylate) described for the component (b1) of the first embodiment may be used as a crosslinking agent that is further added to the curable composition, if desired.

In addition, as described for the first embodiment, a filler component, an additional polymerization initiator, a tackifier, a coupling agent, an impact resistance modifier and the like may be added to the curable composition. In the present disclosure, in view of production efficiency or the like, the curable composition is preferably made to be ultraviolet curable by using a photopolymerization initiator as the polymerization initiator present in the curable composition.

In the thus-obtained curable composition before foaming and curing, a copolymer as the component (c2) is crosslinked through an acid-base interaction brought about between the carboxyl group contained in the copolymer and the basic group present on the particle surface of the thermally conductive filler. The viscosity of the curable composition is, similarly to the first embodiment, preferably controlled to be, for example, from about 5,000 mPa·s to about 60,000 mPa·s.

According to the second embodiment of the present disclosure, a pressure-sensitive adhesive foam containing a foamed cured product of the above-described curable composition is provided. By virtue of the crosslink through an acid-base interaction of the carboxyl group of the component (c2) as a copolymer of the component (a) and the component (b2) with the basic group present on the particle surface of the thermally conductive filler, the pressure-sensitive adhesive foam of the present disclosure exerts comparable or higher pressure-sensitive adhesive performance and flexibility even when the amount of the foaming adjuvant containing surface modified nanoparticles is drastically decreased compared with a conventional curable composition. Also, in the case of using the foaming adjuvant in the same amount as in the conventional composition, a pressure-sensitive adhesive foam with excellent pressure-sensitive adhesive, adherence and sealing properties and lower density can be produced.

As described in the first embodiment, the value η_{foam} (=(parts by weight of the foaming adjuvant based on 100 parts by weight of the resin component of the curable composition)/(content of air bubbles of the pressure-sensitive adhesive foam)) of the pressure-sensitive adhesive foam of the present disclosure obtained by foaming and curing the above-described curable composition is from about 0.02 to about 0.05. By adjusting the value to this range, sufficient thermal conductivity can be imparted to the pressure-sensitive adhesive foam while maintaining flexibility of the pressure-sensitive adhesive foam.

The average diameter of air bubbles contained in the pressure-sensitive adhesive foam is usually about 300 μm or less. As described for the first embodiment, the content of the air bubbles of the pressure-sensitive adhesive foam may be appropriately adjusted and is preferably adjusted to be from 5 to 25% by volume based on the entire volume of the foam.

The foaming and curing of the curable composition can be performed as described in the first embodiment.

The pressure-sensitive adhesive foam according to the third embodiment of the present disclosure is obtained by foaming and curing a curable composition containing a crosslinked structure having both the crosslink in the first embodiment and the crosslink in the second embodiment. One embodiment of the pressure-sensitive adhesive foam above is a foam obtained by foaming and curing a curable composition comprising: a partial polymer containing (a) one or more alkyl (meth)acrylate monomers having one reactive unsaturated group, the alkyl group having 12 or less carbon atoms, (b1) one or more monomers having two or more reactive unsaturated groups, (b2) one or more monomers having a carboxyl group, and (c3) a copolymer of the component (a), the component (b1) and the component (b2); a thermally conductive filler that is a metal hydroxide having a basic group on the particle surface; and a foaming adjuvant containing surface modified nanoparticles. A crosslinked structure in which the component (a) is copolymerized with the component (b1) to form a crosslink and in which the component (c3) is crosslinked through the component (b2) in the component (c3) and the thermally conductive filler, is formed in the curable composition. In this embodiment, the copolymer as the component (c3) is a crosslinked copolymer having a crosslink produced by the copolymerization reaction of the component (a) and the component (b1) (a crosslink through a covalent bond). In addition, a plurality of crosslinked copolymer molecules are attracted to the thermally conductive filler through an acid-base interaction brought about between the carboxyl group derived from the component (b2) contained in the crosslinked copolymer and the basic group present on the particle surface of the thermally conductive filler, as a result, a crosslink is further formed among the plurality of crosslinked copolymer molecules. The crosslinked structure having both types of crosslink enhances foamability of the curable composition and even when the amount of the foaming adjuvant is small compared with the conventional composition, a foam having a desired content of air bubbles can be formed by inhibiting defoaming during molding and curing steps.

The pressure-sensitive adhesive foam according to the third embodiment can be obtained in the same manner as described above for the first and second embodiments except that in producing the partial polymer, the partial polymerization is performed using (b1) a monomer having two or more reactive unsaturated groups and (b2) a monomer having a carboxyl group. The kind and amount used of each component, the production methods of the partial polymer, curable composition and pressure-sensitive adhesive foam, and the like are as described above in the first and second embodiments.

The pressure-sensitive adhesive foam according to the third embodiment may satisfy, for example, any one of the following conditions or a combination thereof:

the monomer mixture has a composition comprising, based on the weight of the monomer mixture, from about 80% by weight to about 98.98% by weight of the component (a), from about 0.01% by weight to about 1.0% by weight of the component (b1), from about 1% by weight to about 19.98% by weight of the component (b2), and from about 0.01% by weight to about 1.5% by weight of the component (d);

the amount of the component (c3) is from about 2% by weight to about 15% by weigh based on the weight of the partial polymer;

the viscosity at 25° C. of the partial copolymer is about 200 mPa·s or more, about 500 mPa·s or more or about 1,000 mPa·s or more, and about 10,000 mPa·s or less, about 5,000 mPa·s or less or about 2,000 mPa·s or less;

the mean particle diameter of the thermally conductive filler is about 10 μm or more, about 30 μm or more or about 40 μm or more, and about 150 μm or less, about 100 μm or less or about 80 μm or less;

the amount of the thermally conductive filler is about 60 parts by weight or more or about 100 parts by weight or more, and about 300 parts by weight or less or about 250 parts by weight or less, per 100 parts by weight of the partial polymer;

the particle diameter of the surface modified nanoparticle is about 20 nm or less and the amount of the foaming adjuvant containing such surface modified nanoparticles is from about 0.1 parts by weight to about 1.5 parts by weight per 100 parts by weight of the partial polymer;

the viscosity of the curable composition is from about 5,000 mPa·s to about 60,000 mPa·s;

η_{foam} (=(parts by weight of the foaming adjuvant based on 100 parts by weight of the resin component of the curable composition)/(content of air bubbles of the pressure-sensitive adhesive foam)) is from about 0.02 to about 0.05; and

the content of the air bubbles is from 5 to 25% by volume based on the entire volume of the foam.

Since the pressure-sensitive adhesive foam of the present disclosure contains the thermally conductive filler, the thermal conductivity is high, for example, about 0.4 μm⁻¹ K⁻¹ or more. Therefore, the pressure-sensitive adhesive foam of the present disclosure can be used as a thermally conductive material for transferring heat from a heating element mounted in various electronic devices such as heat generating electronic devices and personal computers, to radiators such as heat sinks and metal heat radiating plates. For example, the pressure-sensitive adhesive foam of the present disclosure is used after forming into a tape or a sheet. Since such a foam tape or foam sheet contains air bubbles, it is easy to handle and is excellent in adhesion to heating elements and radiators, and also exhibits good thermal conductivity.

### EXAMPLES

While typical examples will be described in detail below, modification and variation of the present disclosure which will be obvious to those skilled in the art are to be covered within the scope of the claims of the present application.

The pressure-sensitive adhesive foam was evaluated by the following procedures.

90 Degree Peel Adhesive Force (with Respect to Stainless Steel Plate)

The resulting sheet was cut into a size measuring 25 mm×200 mm and lined with an anodized aluminum foil (130 μm). The lined sample was laid on a stainless steel plate (SUS304) and then contact-bonded by pressing using a roller of 7 kg for one round trip. After contact bonding, the resulting sample was allowed to stand at room temperature for 72 hours and peeled at a 90 degree direction at a testing speed of 300 mm/min using TENSILON, and then the peel adhesive force during testing was measured. The measurement was carried out using two samples and the average was taken as the 90 degree peel adhesive force.

### Heat Resistant Shear Holding Force

The resulting sheet was cut into a size measuring 25 mm×25 mm and a SUS plate was laid on both surfaces of the sheet. The sheet and the SUS plate were contact-bonded by allowing to stand for 20 minutes while placing a weight of 2 kg on the sample placed horizontally. After contact bonding, one SUS plate was fixed under an atmosphere at 90° C. so as to hold the sample vertically, and a weight of 1 kg was applied on the other one SUS plate, and then the time until the same falls was measured. As a result of the measurement, regarding the sample which does not drop for 5,000 minutes or more, the symbol “5,000+” was described in the table. The measurement was carried out using two samples and the average was taken as the heat resistant shear holding force.

### Compressive Stress

Ten sheets thus obtained were laminated and cut into a size measuring 15 mm×15 mm to obtain a measuring sample. The load required for the measuring sample to compress to 75% of an initial thickness per unit area in a thickness direction (25% compressive load) was measured. In the measurement, the sample was compressed at a rate of 0.5 mm/min using TENSILON and a maximum value when the thickness was compressed by 25% was measured. The measurement was carried out using two samples and the average was taken as a compressive stress. As the compressive load value becomes smaller, it is possible to satisfactorily adhere to the adherend under a low contact pressure.

### Content of Air Bubbles

The content of the air bubbles K in the resulting sheet was determined by the following equation.

K(% by volume)=100−(density of foamed sheet/density of non-foamed sheet)×100 (where density of the non-foamed sheet is a density of a sheet obtained using the same curable composition as in the foamed sheet and curing without introducing air bubbles)

### Thermal Conductivity

A small piece measuring 0.01 m×0.01 m (measuring area: 1.0×10⁻⁴ m²) of the thermally conductive sheet (thickness is L (m)) to be measured was made as a specimen and the specimen was interposed between a heating plate and a cooling plate. Then, the difference in temperature between the heating plate and the cooling plate when maintained under a constant load of 7.6×10⁴ N/m² at an electric power of 4.8 W for 5 minutes was measured, and thermal conductivity R_{L} was determined from the following equation.

R_{L}=(K·m²/W)=temperature difference (K)×measuring area (m²)/electric power (W)

Furthermore, two small pieces described above were laminated to make a sample and the thermal conductivity R_{2L} (K·m²/W) of the sample having a thickness of 2 L (m) was measured as described above. Using R_{L} and R_{2L} obtained by the measurement, the thermal conductivity λ (W/m·K) was calculated by the following equation.

λ(W/m·K)=L(m)/((R_{2L}(K·m²/W)−R_{L}(K·m²/W))

### Measurement of Viscosity

The viscosity of the partial polymer was measured using a B-type viscometer (Model: BH) manufactured by Tokyo Keiki Co., Ltd. The measurement was performed at 25° C. by using a #5 or #6 rotor (rotation number: 20 rpm), and the value 1 minute after the start of measurement was used as the measured value.

### Measurement of Breakage Time

The spinnability of the partial polymer was evaluated using an elongation viscometer, CaBER 1, manufactured by Thermo HAAKE. The elongation viscometer is an apparatus where a sample is sealed between a pair of concentrically and vertically disposed circular plates, the top plate is lifted upwardly and kept as it is, thereby forming a filament of the sample, and the time-varying change of the diameter in the filament portion (filament diameter) is measured using a laser micrometer. The filament diameter of the sample decreases with the passing of time, and the filament is finally broken. As the filament diameter is more likely to change not rapidly but gradually and the breakage time is longer, the partial polymer has higher spinnability.

The test conditions were as follows. The partial polymer was sealed between a pair of concentrically and vertically disposed circular plates of 6 mm in diameter (gap: 1.0 mm), the top plate was vertically lifted at 25° C. at a speed of 50.0 m/min until the distance between top and bottom circular plates became 7.0 mm, and kept as it was, and the time (tₘₐₓ) from immediately after lifting of the plate to breakage of the partial polymer filament was measured. The measurement was repeated two times on the same sample, and the average value thereof was used as the measured value.

Comparing a partial polymer having a crosslink and a partial polymer having no crosslink, where the viscosity obtained by the measurement of viscosity above was at the same level, the breakage time of the partial polymer having a crosslink tends to be longer. It is considered that when the viscosity by the measurement of viscosity above is the same, a partial polymer having a longer breakage time exhibits a higher effect of suppressing defoaming. For example, as to the partial polymer used in the first or third embodiment of the present disclosure, A in the following relational expression is preferably 1.7 or more or 2.0 or more.

Breakage time tₘₐₓ(sec)≧A×viscosity(mPa·s,25° C.)−10(viscosity range: from 1000 to 20000 mPa·s)

### Preparation of Surface Modified Nanoparticles

In this example, isooctylsilane surface modified silica nanoparticles obtained by modifying a surface of silica nanoparticles with isooctyltrimethoxysilane were used. The preparation method is as follows. 61.42 g of isooctyltrimethoxysilane (article number: BS1316, Wacker Silicone Corp, Adrian, Mich.), 1,940 g of 1-methoxy-2-propanol and 1,000 g of colloidal silica (article number: NALCO2326, Nalco Chemical Co.) were mixed in a 1 gallon glass jar. The mixture was sufficiently dispersed by shaking and then allowed to stand in an oven at 80° C. overnight. The mixture was dried in a ventilated oven at 150° C. to obtain white solid microparticles. The surface modified nanoparticles thus obtained had a particle diameter of about 5 nm.

### Examples 1 to 7

The mixture of monomers and a polymerization initiator prepared according to the formulation described in the item A of Table 1 was subjected to partial polymerization by irradiation with ultraviolet light under a nitrogen atmosphere at an irradiation intensity of 3 mW/cm² for 3 minutes to obtain a partial polymer. In Examples 1 to 4,2-ethylhexyl acrylate (2-EHA) was used as the component (a) and the amount of the component (b1) (1,6-hexanediol diacrylate (HDDA)) was varied, and then partial polymerization was carried out. In Examples 5 to 7, isooctyl acrylate was used as the component (a) and three kinds of the component (b1) (HDDA, BLEMMER ADE-400 and BLEMMER ADE-600) were used. BLEMMER ADE-400 and BLEMMER ADE-600 are polyethyleneglycol diacrylates manufactured by NOF Corp. Table 2 is a composition table in which only the item A was reconstituted based on 100 parts by weight of 2-EHA or isooctyl acrylate. In Table 2, viscosity of the partial polymer and the content of the copolymer in the partial polymer are expressed by a weight percentage based on the weight of the partial polymer.

The content of the copolymer in the partial polymer was determined in the following manner. 1.0 g of the resulting partial polymer was weighed in a stainless steel plate (a diameter of the bottom: 4.0 cm) and then dried under a nitrogen atmosphere at 130° C. for 2 hours to obtain a solid (copolymer). The solid was weighed and the content (% by weight) of the copolymer was calculated based on the weight (1.0 g) of the partial polymer charged.

TABLE 1
Table of composition (total)

| | | Composition (parts by weight) | | | | | | | | |
|---|---|---|---|---|---|---|---|---|---|---|
| | | | | | | | | | Comp. | Comp. |
| Component | | Ex. 1 | Ex. 2 | Ex. 3 | Ex. 4 | Ex. 5 | Ex. 6 | Ex. 7 | Ex. 1 | Ex. 2 |
| A¹⁾ | 2-ethylhexyl acrylate (2-HEA) | 97 | 97 | 97 | 97 | — | — | — | 97 | 97 |
| | Isooctyl acrylate | — | — | — | — | 97 | 97 | 97 | — | — |
| | 1,6-hexanediol diacrylate (HDDA) | 0.10 | 0.10 | 0.05 | 0.02 | — | — | 0.10 | — | — |
| | BLEMMER ADE-400⁵⁾ | — | — | — | — | 0.30 | — | — | — | — |
| | BLEMMER ADE-600⁶⁾ | — | — | — | — | — | 0.60 | — | — | — |
| | Irgacure 651⁷⁾ | 0.04 | 0.04 | 0.04 | 0.04 | 0.04 | 0.04 | 0.10 | 0.04 | 0.04 |
| B²⁾ | Acrylic acid | 3 | 3 | 3 | 3 | 3 | 3 | 3 | 3 | 3 |
| | 1,6-hexanediol diacrylate | — | — | 0.05 | 0.08 | — | — | — | 0.10 | 0.10 |
| | Irgacure 819⁸⁾ | 0.30 | 0.30 | 0.30 | 0.30 | 0.30 | 0.30 | 0.15 | 0.30 | 0.30 |
| C³⁾ | Aluminium hydroxide⁹⁾ | 150 | 150 | 150 | 150 | 150 | 150 | 150 | 150 | 150 |
| D⁴⁾ | Surface-modified nanoparticles¹⁰⁾ | 0.43 | 0.85 | 0.43 | 0.43 | 0.43 | 0.43 | 0.43 | 0.43 | 0.85 |

¹⁾Starting material of (meth)acrylic partial polymer
²⁾Components added to (meth)acrylic partial polymer
³⁾Thermally conductive filler
⁴⁾Foaming adjuvant
⁵⁾Trade name (Supplier: NOF Corp.)
⁶⁾Trade name (Supplier: NOF Corp.)
⁷⁾Trade name (Supplier: Ciba Japan K.K.)
⁸⁾Trade name (Supplier: Ciba Japan K.K.)
⁹⁾Mean particle size: 50 μm
¹⁰⁾Isooctylsilane surface modified silica nanoparticles

TABLE 2
Composition and properties of partial polymer (reconstituted from Table 1)

| | | Composition (parts by weight) | | | | | | | | |
|---|---|---|---|---|---|---|---|---|---|---|
| | | | | | | | | | Comp. | Comp. |
| Component | | Ex. 1 | Ex. 2 | Ex. 3 | Ex. 4 | Ex. 5 | Ex. 6 | Ex. 7 | Ex. 1 | Ex. 2 |
| A | 2-ethylhexyl acrylate (2-HEA) | 100 | 100 | 100 | 100 | — | — | — | 100 | 100 |
| | Isooctyl acrylate | — | — | — | — | 100 | 100 | 100 | — | — |
| | 1,6-hexanediol diacrylate (HDDA) | 0.10 | 0.10 | 0.05 | 0.02 | — | — | 0.10 | — | — |
| | BLEMMER ADE-400 | — | — | — | — | 0.31 | — | — | — | — |
| | BLEMMER ADE-600 | — | — | — | — | — | 0.62 | — | — | — |
| | Irgacure 651 | 0.04 | 0.04 | 0.04 | 0.04 | 0.04 | 0.04 | 0.10 | 0.04 | 0.04 |

| | | | | | | | | | |
|---|---|---|---|---|---|---|---|---|---|
| Viscosity of partially polymerized product | 2500 | 3300 | 4000 | 9800 | 2600 | 1500 | 1800 | 3800 | 3800 |
| (mPa · s) | | | | | | | | | |
| Content of copolymer contained in partially | 4.0 | 4.2 | 5.5 | 8.0 | 4.8 | 3.9 | 5.0 | — | — |
| polymerized product (% by weight) | | | | | | | | | |

To the partial polymer, acrylic acid (a polar group-containing monomer), HDDA and Irgacure 819 (a polymerization initiator) as additional components were added according to the formulation described in the item B of Table 1. Furthermore, aluminum hydroxide (a thermally conductive filler) described in the item C was added, followed by sufficiently stirring and further deaeration using a vacuum deaerator. Then, surface modified nanoparticles (a foaming adjuvant) described in the item D were added to obtain a curable composition. In Example 2, the content of surface modified nanoparticles used in Example 1 was doubled. In Example 3 and Example 4, HDDA (the amount was decreased upon partial polymerization compared with Example 1) was added later and the amount of HDDA used for preparation of the curable composition was adjusted to the same amount with respect to Examples 1 to 4. Table 3 is a composition table in which the items B, C and D were reconstituted based on 100 parts by weight of the partial polymer.

TABLE 3
Curable composition (reconstituted from Table 1)

| | | Composition (parts by weight) | | | | | | | | |
|---|---|---|---|---|---|---|---|---|---|---|
| | | | | | | | | | Comp. | Comp. |
| Component | | Ex. 1 | Ex. 2 | Ex. 3 | Ex. 4 | Ex. 5 | Ex. 6 | Ex. 7 | Ex. 1 | Ex. 2 |
| | Partial polymer | 100 | 100 | 100 | 100 | 100 | 100 | 100 | 100 | 100 |
| B | Acrylic acid | 3.1 | 3.1 | 3.1 | 3.1 | 3.1 | 3.1 | 3.1 | 3.1 | 3.1 |
| | 1,6-hexanediol diacrylate | — | — | 0.05 | 0.08 | — | — | — | 0.10 | 0.10 |
| | Irgacure 819 | 0.31 | 0.31 | 0.31 | 0.31 | 0.31 | 0.31 | 0.15 | 0.31 | 0.31 |
| C | Aluminium hydroxide | 154 | 154 | 154 | 155 | 154 | 154 | 154 | 155 | 155 |
| D | Surface-modified nanoparticles | 0.44 | 0.88 | 0.44 | 0.44 | 0.44 | 0.44 | 0.44 | 0.44 | 0.88 |

Using a vibrational stirring/mixing device, nitrogen gas was dispersed in this curable composition to obtain a foamed curable composition. The foamed curable composition was interposed between two polyethylene terephthalate (PET) liners having a surface treated with a silicone release agent and then a sheet was formed by calender molding. While interposing the curable composition into two PET liners, the composition was cured by irradiating both surfaces of the sheet with ultraviolet light at an irradiation intensity of 0.3 mW/cm² for 3 minutes and then irradiating with ultraviolet light at an irradiation intensity of 6.0 mW/cm² for 3 minutes to obtain an acrylic pressure-sensitive adhesive foam sheet.

In the same manner as in Example 1, except that the foaming adjuvant (item D) was not added so as to obtain a non-foamed sheet used to calculate the content of the air bubbles of pressure-sensitive adhesive foams of Examples 1 to 7, a curable composition containing no foaming adjuvant was obtained. This curable composition was interposed between two polyethylene terephthalate (PET) liners having a surface treated with a silicone release agent and then a sheet was formed by calender molding. While interposing the curable composition between the two PET liners, the composition was cured by irradiating both surfaces of the sheet with ultraviolet light at an irradiation intensity of 0.3 mW/cm² for 3 minutes and then irradiating with ultraviolet light at an irradiation intensity of 6.0 mW/cm² for 3 minutes to obtain an acrylic pressure-sensitive adhesive non-foamed sheet. The resulting sheet had a density of 1.51 g/cm³.

### Comparative Example 1

In the same manner as in Example 1, except that HDDA was added after only 2-ethylhexyl acrylate was subjected to partial polymerization, a 0.30 mm thick acrylic pressure-sensitive adhesive foam sheet was obtained. The resulting sheet had a density of 1.39 g/cm³, and air bubbles having a comparatively large size such that these bubbles pierce the sheet were locally observed.

### Comparative Example 2

In the same manner as in Comparative Example 1, except that the amount of surface modified nanoparticles were increased (0.85 parts by weight), a 0.30 mm thick acrylic pressure-sensitive adhesive foam sheet was obtained. The resulting sheet had a density of 1.31 g/cm³.

In the same manner as in Comparative Example 1, except that the foaming adjuvant (item D) was not added so as to obtain a non-foamed sheet used to calculate the content of the air bubbles of pressure-sensitive adhesive foams of Comparative Examples 1 and 2, a curable composition containing no foaming adjuvant was obtained. This curable composition was interposed between two polyethylene terephthalate (PET) liners having a surface treated with a silicone release agent and then a sheet was formed by calender molding. While interposing the curable composition between the two PET liners, the composition was cured by irradiating both surfaces of the sheet with ultraviolet light at an irradiation intensity of 0.3 mW/cm² for 3 minutes and then irradiating with ultraviolet light at an irradiation intensity of 6.0 mW/cm² for 3 minutes to obtain a 0.30 mm thick acrylic adhesive non-foamed sheet. The resulting sheet had a density of 1.51 g/cm³.

With respect to these pressure-sensitive adhesive foamed sheets thus obtained, 90 degree peel adhesive force, heat resistant shear holding force, compressive stress, content of air bubbles, thermal conductivity and η_{foam} were evaluated by the above procedures. The results are shown in Table 4.

TABLE 4
Results of evaluation

| | | | | | | | | Comp. | Comp. |
|---|---|---|---|---|---|---|---|---|---|
| | Ex. 1 | Ex. 2 | Ex. 3 | Ex. 4 | Ex. 5 | Ex. 6 | Ex. 7 | Ex. 1 | Ex. 2 |
| Sheet thickness (mm) | 0.3 | 1 | 0.3 | 1 | 0.3 | 1 | 0.3 | 0.3 | 0.3 |
| 90 degree peel adhesion strength | 2.8 | 3.6 | 2.8 | 3.3 | 3.1 | 3.5 | 3 | 2.9 | 2.8 |
| (Ncm⁻¹) | | | | | | | | | |
| Heat resistant shear adhesion | 5000+ | 5000+ | 5000+ | 5000+ | 5000+ | 5000+ | 5000+ | 5000+ | 5000+ |
| strength (min) | | | | | | | | | |
| 25% compression load (Ncm⁻²) | 13 | 9.4 | 14.2 | 14.4 | 11 | 10.8 | 13.1 | 16.8 | 14.6 |
| Air bubbles content (volume %) | 13.9 | 21.6 | 11.8 | 11.1 | 13.5 | 15 | 13.2 | 7.9 | 13.2 |
| Thermal conductivity (Wm⁻¹K⁻¹) | 0.7 | 0.5 | 0.7 | 0.7 | 0.7 | 0.7 | 0.7 | 0.8 | 0.7 |
| η_{foam} | 0.031 | 0.039 | 0.036 | 0.039 | 0.032 | 0.029 | 0.033 | 0.054 | 0.064 |

A relation between the thickness of the sheet and the density of the sheet upon variation of the thickness of the sheet of Example 1 and Comparative Example 1 is shown in Table 5. The specific gravity of the foamed curable composition was adjusted within a range from 1.20 to 1.22 g/cm³.

TABLE 5
Sheet thickness and sheet density

Sheet density
(g/cm³)

| Sheet thickness (mm) | Ex. 1 | Comp. Ex. 1 | Difference |
|---|---|---|---|
| 1.20 | 1.25 | 1.31 | 0.06 |
| 0.60 | 1.25 | 1.32 | 0.07 |
| 0.30 | 1.30 | 1.39 | 0.09 |

### Example 8

The composition described in the item A of Table 6 was thoroughly stirred and then irradiated with ultraviolet light at an irradiation intensity of 3 mW/cm² for 3 minutes under a nitrogen atmosphere to obtain a partial polymer. The components described in the item B of Table 6 were added to the partial polymer above, and the resulting mixture was thoroughly stirred and then deaerated using a vacuum deaerator. Thereafter, surface modified nanoparticles in the item C were added as a foaming adjuvant to obtain a curable composition, and nitrogen gas was dispersed in this curable composition by using a vibrational stirring/mixing device to obtain a foamed curable composition with a density of 1.19 g/cm³. The foamed curable composition was interposed between two polyethylene terephthalate (PET) liners each surface-treated with a silicone release agent and then a sheet was formed by calender molding. While holding the curable composition inside of two PET liners, the composition was cured by irradiating both surfaces of the sheet with ultraviolet light at an irradiation intensity of 0.3 mW/cm² for 3 minutes and then with ultraviolet light at an irradiation intensity of 6.0 mW/cm² for 3 minutes to obtain a 0.30 mm-thick pressure-sensitive adhesive foam sheet. The density of the obtained sheet was 1.27 g/cm³.

### Comparative Example 3

A 0.30 mm-thick pressure-sensitive adhesive foam sheet was obtained in the same manner as in Example 8 except that the partial polymer was obtained without using acrylic acid but the total amount of acrylic acid used was the same as in Example 8. The density of the obtained sheet was 1.39 g/cm³. The size of air bubbles in the sheet was relatively large and an air bubble as large as penetrating the sheet was locally observed.

### Comparative Example 4

A 0.30 mm-thick pressure-sensitive adhesive foam sheet was obtained in the same manner as in Comparative Example 3 except that the amount of surface modified nanoparticles added was changed to 0.85 parts by weight. The density of the obtained sheet was 1.31 g/cm³.

### Comparative Example 5

A 0.30 mm-thick pressure-sensitive adhesive foam sheet was obtained in the same manner as in Comparative Example 4 except that the partial polymerization was performed to obtain a partial polymer having a viscosity of 2,000 mPa·s. The density of the obtained sheet was 1.37 g/cm³.

### Comparative Example 6

A 0.30 mm-thick pressure-sensitive adhesive foam sheet was obtained in the same manner as in Comparative Example 3 except that surface modified nanoparticles were not used and a vibrational stirring/mixing device was not used. The density of the obtained sheet was 1.50 g/cm³.

The viscosity of the partial polymer obtained from the components in the item A and the viscosity of a mixture of the partial polymer obtained from the components in the item A with the components in the item B are shown in Table 7. Also, in Table 7, the content of the copolymer contained in the partial polymer is shown by a weight percentage based on the weight of the partial polymer.

These pressure-sensitive adhesive foam sheets or pressure-sensitive adhesive non-foamed sheets produced above were evaluated for the 90° peel adhesive force, heat resistant shear holding force, content of air bubbles, thermal conductivity and η_{foam} in accordance with the above-described procedures. The results are shown in Table 7.

TABLE 6
Table of Composition

| | | Composition (parts by weight) | | | | |
|---|---|---|---|---|---|---|
| | | | Comp. | Comp. | Comp. | Comp. |
| Component | | Ex. 8 | Ex. 3 | Ex. 4 | Ex. 5 | Ex. 6 |
| A¹⁾ | 2-Ethylhexyl acrylate (2-HEA) | 97 | 97 | 97 | 97 | 97 |
| | Irgacure 651⁴⁾ (photopolymerization | 0.04 | 0.04 | 0.04 | 0.04 | 0.04 |
| | initiator) | | | | | |
| | Acrylic acid | 2 | — | — | — | — |
| B²⁾ | 1,6-Hexanediol diacrylate (crosslinking | 0.10 | 0.10 | 0.10 | 0.10 | 0.10 |
| | agent) | | | | | |
| | Acrylic acid | 1 | 3 | 3 | 3 | 3 |
| | Irgacure 819⁵⁾ (photopolymerization | 0.30 | 0.30 | 0.30 | 0.30 | 0.30 |
| | initiator) | | | | | |
| | Aluminum hydroxide⁶⁾ (thermally | 150 | 150 | 150 | 150 | 150 |
| | conductive filler) | | | | | |
| C³⁾ | Surface modified nanoparticles⁷⁾ | 0.425 | 0.425 | 0.85 | 0.85 | — |

¹⁾Starting material of (meth)acrylic partial polymer
²⁾Components added to (meth)acrylic partial polymer (excluding foaming adjuvant)
³⁾Foaming adjuvant
⁴⁾Trade name (supplier: Ciba Japan K.K.)
⁵⁾Trade name (supplier: Ciba Japan K.K.)
⁶⁾Mean particle size: 50 μm
⁷⁾Isooctylsilane surface modified silica nanoparticles

TABLE 7
Results of Evaluation

| | | Comp. | Comp. | Comp. | Comp. |
|---|---|---|---|---|---|
| | Ex. 8 | Ex. 3 | Ex. 4 | Ex. 5 | Ex. 6 |
| Viscosity of partial polymer obtained | 1000 | 5000 | 5000 | 2000 | 5000 |
| from A (mPa · s) | | | | | |
| Viscosity of a mixture of partial | 7000 | 15000 | 15000 | 7500 | 15000 |
| polymer obtained from A with B | | | | | |
| (mPa · s) | | | | | |
| Content of copolymer contained | 2.2 | 6.3 | 6.3 | 3.1 | 6.3 |
| in partial polymer (% by weight) | | | | | |
| 90° Peel adhesive force (Ncm⁻¹) | 2.8 | 2.9 | 2.8 | 2.8 | 2.8 |
| Heat resistant shear holding | 5000+ | 5000+ | 5000+ | 5000+ | 5000+ |
| force (min) | | | | | |
| Content of air bubbles | 15.3 | 7.3 | 12.6 | 8.6 | 0 |
| (% by volume) | | | | | |
| Thermal conductivity | 0.7 | 0.7 | 0.7 | 0.7 | 0.9 |
| (Wm⁻¹K⁻¹) | | | | | |
| η_{foam} | 0.028 | 0.058 | 0.067 | 0.098 | — |

### Example 9

A mixture of monomers and a polymerization initiator prepared according to the composition described in the item A of Table 8 was irradiated with ultraviolet light at an irradiation intensity of 3 mW/cm² for 3 minutes under a nitrogen atmosphere to obtain a partial polymer. In Table 8, the viscosity of the partial polymer of Example 9 and the content of the copolymer contained in the partial polymer expressed by a weight percentage based on the weight of the partial polymer are shown together with Examples 1 to 7 and Comparative Examples 1 and 2. Also, the breakage time measured on the partial polymers of Examples 1 to 7 and 9 and Comparative Examples 1 and 2 are shown in Table 8.

To the partial polymer, acrylic acid (polar group-containing monomer), HDDA and Irgacure 819 (polymerization initiator) as additional components were added according to the formulation described in the item B of Table 9. Furthermore, aluminum hydroxide (thermally conductive filler) described in the item C was added, and the resulting mixture was thoroughly stirred and then deaerated using a vacuum deaerator. Thereafter, surface modified nanoparticles (foaming adjuvant) described in the item D were added to obtain a curable composition. Table 9 is a composition table showing the blending amounts of items B, C and D based on 100 parts by weight of the partial polymer.

Subsequently, using a vibrational stirring/mixing device, nitrogen gas was dispersed in this curable composition to obtain a foamed curable composition. The foamed curable composition was interposed between two polyethylene terephthalate (PET) liners each surface-treated with a silicone release agent and then a sheet was formed by calender molding. While holding the curable composition inside of two PET liners, the composition was cured by irradiating both surfaces of the sheet with ultraviolet light at an irradiation intensity of 0.3 mW/cm² for 3 minutes and then with ultraviolet light at an irradiation intensity of 6.0 mW/cm² for 3 minutes to obtain an acrylic pressure-sensitive adhesive foam sheet.

The pressure-sensitive adhesive foamed sheet produced was evaluated for the 90° peel adhesive force, heat resistant shear holding force, compressive stress, content of air bubbles, thermal conductivity and η_{foam} in accordance with the above-described procedures. The results are shown in Table 10 together with Examples 1 to 7 and Comparative Examples 1 and 2.

TABLE 8
Composition and Properties of Partial Polymer (Example 9)

| | | Composition (parts by weight) | | | | | | | | | |
|---|---|---|---|---|---|---|---|---|---|---|---|
| | | | | | | | | | | Comp. | Comp. |
| Component | | Ex. 1 | Ex. 2 | Ex. 3 | Ex. 4 | Ex. 5 | Ex. 6 | Ex. 7 | Ex. 9 | Ex. 1 | Ex. 2 |
| A | 2-Ethylhexyl acrylate (2HEA) | 100 | 100 | 100 | 100 | — | — | — | 98 | 100 | 100 |
| | Isooctyl acrylate | — | — | — | — | 100 | 100 | 100 | — | — | — |
| | Acrylic acid | — | — | — | — | — | — | — | 2 | — | — |
| | 1,6-hexanediol diacrylate (HDDA) | 0.10 | 0.10 | 0.05 | 0.02 | — | — | 0.10 | 0.03 | — | — |
| | BLEMMER ADE-400 | — | — | — | — | 0.31 | — | — | — | — | — |
| | BLEMMER ADE-600 | — | — | — | — | — | 0.62 | — | — | — | — |
| | Irgacure 651 | 0.04 | 0.04 | 0.04 | 0.04 | 0.04 | 0.04 | 0.10 | 0.04 | 0.04 | 0.04 |

| | | | | | | | | | | |
|---|---|---|---|---|---|---|---|---|---|---|
| Viscosity of partial polymer (mPa · s) | 2500 | 3300 | 4000 | 9800 | 2600 | 1500 | 1800 | 3900 | 3800 | 3800 |
| Content of copolymer contained in partial polymer | 4.0 | 4.2 | 5.5 | 8.0 | 4.8 | 3.9 | 5.0 | 5.1 | 4.4 | 4.4 |
| (% by weight) | | | | | | | | | | |
| Breakage time (sec) | 4.8 | 5.4 | 5.1 | 5.9 | 4.2 | 3.4 | 3.9 | 3.8 | 2.7 | 2.7 |

TABLE 9
Formulation of Curable Composition (Example 9)

| | | Composition (parts by weight) | | | | | | | | | |
|---|---|---|---|---|---|---|---|---|---|---|---|
| | | | | | | | | | | Comp. | Comp. |
| Component | | Ex. 1 | Ex. 2 | Ex. 3 | Ex. 4 | Ex. 5 | Ex. 6 | Ex. 7 | Ex. 9 | Ex. 1 | Ex. 2 |
| A | Partial polymer | 100 | 100 | 100 | 100 | 100 | 100 | 100 | 100 | 100 | 100 |
| B | Acrylic acid | 3.1 | 3.1 | 3.1 | 3.1 | 3.1 | 3.1 | 3.1 | 1.0 | 3.1 | 3.1 |
| | 1,6-Hexanediol diacrylate (HDDA) | — | — | 0.05 | 0.08 | — | — | — | 0.07 | 0.10 | 0.10 |
| | Irgacure 819 | 0.31 | 0.31 | 0.31 | 0.31 | 0.31 | 0.31 | 0.15 | 0.30 | 0.31 | 0.31 |
| C | Aluminum hydroxide | 154 | 154 | 154 | 155 | 154 | 154 | 154 | 154 | 155 | 155 |
| D | Surface modified nanoparticles | 0.44 | 0.88 | 0.44 | 0.44 | 0.44 | 0.44 | 0.44 | 0.44 | 0.44 | 0.88 |

TABLE 10
Results of Evaluation (Example 9)

| | | | | | | | | | Comp. | Comp. |
|---|---|---|---|---|---|---|---|---|---|---|
| | Ex. 1 | Ex. 2 | Ex. 3 | Ex. 4 | Ex. 5 | Ex. 6 | Ex. 7 | Ex. 9 | Ex. 1 | Ex. 2 |
| Sheet thickness (mm) | 0.3 | 1 | 0.3 | 1 | 0.3 | 1 | 0.3 | 0.3 | 0.3 | 0.3 |
| 90° peel adhesive force (Ncm⁻¹) | 2.8 | 3.6 | 2.8 | 3.3 | 3.1 | 3.5 | 3 | 2.8 | 2.9 | 2.8 |
| Heat resistant shear holding force (min) | 5000+ | 5000+ | 5000+ | 5000+ | 5000+ | 5000+ | 5000+ | 5000+ | 5000+ | 5000+ |
| 25% Compressive load (Ncm⁻²) | 13 | 9.4 | 14.2 | 14.4 | 11 | 10.8 | 13.1 | 13 | 16.8 | 14.6 |
| Content of air bubbles (% by volume) | 13.9 | 21.6 | 11.8 | 11.1 | 13.5 | 15 | 13.2 | 14 | 7.9 | 13.2 |
| Thermal conductivity (Wm⁻¹K⁻¹) | 0.7 | 0.5 | 0.7 | 0.7 | 0.7 | 0.7 | 0.7 | 0.7 | 0.8 | 0.7 |
| η_{foam} | 0.031 | 0.039 | 0.036 | 0.039 | 0.032 | 0.029 | 0.033 | 0.031 | 0.054 | 0.064 |

1. A pressure-sensitive adhesive foam, which is a foamed cured product of a curable composition comprising:
a partial polymer comprising
(a) one or more alkyl (meth)acrylate monomers having one reactive unsaturated group, the alkyl group having 12 or less carbon atoms,
(b) a monomer for crosslinking, which is copolymerizable with the component (a), and
(c) a copolymer of the component (a) and the component (b);
a thermally conductive filler; and
a foaming adjuvant containing surface modified nanoparticles having a particle diameter of 20 nm or less,
wherein a crosslinked structure containing said component (c) is formed in said curable composition.

2. The pressure-sensitive adhesive foam, which is a foamed cured product of a curable composition comprising:
a partial polymer comprising
(a) one or more alkyl (meth)acrylate monomers having one reactive unsaturated group, the alkyl group having 12 or less carbon atoms,
(b1) one or more monomers having two or more reactive unsaturated groups, and
(c1) a copolymer of the component (a) and the component (b1), the amount of said component (c1) being from 2% to 15% by weight based on the weight of said partial polymer;
a thermally conductive filler in the amount of 100 to 250 parts by weight based on 100 parts by weight of said partial polymer; and
a foaming adjuvant containing surface modified nanoparticles having a particle diameter of 20 nm or less, in the amount of 0.1 to 1.5 parts by weight based on 100 parts by weight of said partial polymer,
wherein a crosslinked structure formed in said curable composition is a crosslinked copolymer of said component (a) and said component (b1) and
wherein said pressure-sensitive adhesive foam has an air bubble content that is expressed by the volume percentage based on the entire volume of the foam, the value of (parts by weight of said foaming adjuvant based on 100 parts by weight of the resin component of said curable composition)/(content of air bubbles of said pressure-sensitive adhesive foam) is from 0.02 to 0.05.

3. The pressure-sensitive adhesive foam, which is a foamed cured product of a curable composition comprising:
a partial polymer comprising
(a) one or more alkyl (meth)acrylate monomers having one reactive unsaturated group, the alkyl group having 12 or less carbon atoms,
(b2) one or more monomers having a carboxyl group, and
(c2) a copolymer of the component (a) and the component (b2), the amount of said component (c2) being from 2% to 15% by weight based on the weight of said partial polymer;
a thermally conductive filler in the amount of 60 to 300 parts by weight based on 100 parts by weight of said partial polymer, said thermally conductive filler being a metal hydroxide having a basic group on the particle surface; and
a foaming adjuvant containing surface modified nanoparticles having a particle diameter of 20 nm or less, in the amount of 0.1 to 1.5 parts by weight based on 100 parts by weight of said partial polymer,
wherein a crosslinked structure formed in said curable composition is a crosslinked structure in which said component (c2) is crosslinked through said component (b2) in said component (c2) and said thermally conductive filler, and
wherein said pressure-sensitive adhesive foam has an air bubble content that is expressed by the volume percentage based on the entire volume of the foam, the value of (parts by weight of said foaming adjuvant based on 100 parts by weight of the resin component of said curable composition)/(content of air bubbles of said pressure-sensitive adhesive foam) is from 0.02 to 0.05.

4. The pressure-sensitive adhesive foam, which is a foamed cured product of a curable composition comprising:
a partial polymer comprising
(a) one or more alkyl (meth)acrylate monomers having one reactive unsaturated group, the alkyl group having 12 or less carbon atoms,
(b1) one or more monomers having two or more reactive unsaturated groups,
(b2) one or more monomers having a carboxyl group, and
(c3) a copolymer of the component (a), the component (b1) and the component (b2), the amount of said component (c3) being from 2% to 15% by weight based on the weight of said partial polymer;
a thermally conductive filler in the amount of 60 to 300 parts by weight based on 100 parts by weight of said partial polymer, said thermally conductive filler being a metal hydroxide having a basic group on the particle surface; and
a foaming adjuvant containing surface modified nanoparticles having a particle diameter of 20 nm or less, in the amount of 0.1 to 1.5 parts by weight based on 100 parts by weight of said partial polymer,
wherein a crosslinked structure formed in said curable composition is a crosslinked structure in which said component (a) is copolymerized with said component (b1) to form a crosslink and in which said component (c3) is crosslinked through said component (b2) in said component (c3) and said thermally conductive filler, and
wherein said pressure-sensitive adhesive foam has an air bubble content that is expressed by the volume percentage based on the entire volume of the foam, the value of (parts by weight of said foaming adjuvant based on 100 parts by weight of the resin component of said curable composition)/(content of air bubbles of said pressure-sensitive adhesive foam) is from 0.02 to 0.05.

5. The pressure-sensitive adhesive foam of claim 1, having the air bubble content from 5% to 25% by volume based on the entire volume of the foam.

6. The pressure-sensitive adhesive foam of claim 1, wherein said thermally conductive filler is aluminum hydroxide.

7. The pressure-sensitive adhesive foam of claim 1, wherein said curable composition is ultraviolet-curable.

8. (canceled)

9. The pressure-sensitive adhesive foam of claim 2 having the air bubble content from 5% to 25% by volume based on the entire volume of the foam.

10. The pressure-sensitive adhesive foam of claim 2, wherein said thermally conductive filler is aluminum hydroxide.

11. The pressure-sensitive adhesive foam of claim 2, wherein said curable composition is ultraviolet-curable.

12. The pressure-sensitive adhesive foam of claim 3 having the air bubble content from 5% to 25% by volume based on the entire volume of the foam.

13. The pressure-sensitive adhesive foam of claim 3, wherein said thermally conductive filler is aluminum hydroxide.

14. The pressure-sensitive adhesive foam of claim 3, wherein said curable composition is ultraviolet-curable.

15. The pressure-sensitive adhesive foam of claim 4 having the air bubble content from 5% to 25% by volume based on the entire volume of the foam.

16. The pressure-sensitive adhesive foam of claim 4, wherein said thermally conductive filler is aluminum hydroxide.

17. The pressure-sensitive adhesive foam of claim 4, wherein said curable composition is ultraviolet-curable.

18. A method for producing a pressure-sensitive adhesive foam, comprising:
preparing a partial polymer comprising
(a) one or more alkyl (meth)acrylate monomers having one reactive unsaturated group, the alkyl group having 12 or less carbon atoms,
(b) a monomer for crosslinking, which is copolymerizable with the component (a), and
(c) a copolymer of the component (a) and the component (b);
mixing said partial polymer with a thermally conductive filler;
adding a foaming adjuvant containing surface modified nanoparticles having a particle diameter of 20 nm or less to said partial polymer to obtain a curable composition in which a crosslinked structure containing said component (c) is formed;
mechanically foaming said curable composition; and
curing a molded article of said foamed curable composition.
